(19) United States
(12) Patent Application Publication
(10) Pub. No.: US 2025/0077387 A1
(43) Pub. Date: Mar. 6, 2025

(54) Systems and Methods for Trust-Aware Error Detection, Correction, and Explainability in Machine Learning and Computer Vision

(71) Applicant: AvaWatz Company, Dallas, TX (US)

(72) Inventors: Rishabh Iyer, McKinney, TX (US); John McKendry, Ashby, MA (US); Rajini Anachi, Frisco, TX (US)

(73) Assignee: AvaWatz Company, Dallas, TX (US)

(21) Appl. No.: 18/816,968

(22) Filed: Aug. 27, 2024

Related U.S. Application Data
(60) Provisional application No. 63/579,789, filed on Aug. 30, 2023.

(51) Int. Cl. G06F 11/36; G06F 11/07

(52) U.S. Cl. CPC G06F 11/3608; G06F 11/0721; G06F 11/0769

(57) ABSTRACT

Disclosed are methods, systems and non-transitory computer readable memory for trust-aware error detection, correction, and explainability. For instance, a method may include processing a test instance through a machine learning model to obtain a set of inferences; detecting errors in the set of inferences; automatically correcting the errors in the set of inferences and/or updating the machine learning model; determining post-hoc explanations into a cause of the errors; and outputting the post-hoc explanations to a user.

### CROSS-REFERENCE TO RELATED APPLICATION(S)

This application claims the benefit of priority under 35 U.S.C. §§ 120 and 119(e) of U.S. provisional application No. 63/579,789, filed Aug. 30, 2023.

The contents of each of the above referenced applications are hereby incorporated by reference in their entirety.

### TECHNICAL FIELD

Various aspects of the present disclosure relate generally to systems and methods for trust-aware error detection, correction, and explainability and, more particularly, to systems and methods for trust-aware error detection, correction, and explainability in machine learning (ML) and computer vision.

### BACKGROUND

Machine learning and computer vision models have gained widespread adoption across numerous domains. However, these models are not immune to errors, which can arise due to various factors such as biased training data, noise, or model limitations. Identifying and rectifying these mistakes is crucial for ensuring accurate and reliable outputs. Additionally, providing intuitive explanations for model predictions aids users in understanding the underlying reasoning and allows for informed improvements to enhance overall model performance.

The present disclosure is directed to overcoming one or more of these above-referenced challenges.

### SUMMARY OF THE DISCLOSURE

According to certain aspects of the disclosure, systems, methods, and computer readable memory are disclosed for trust-aware error detection, correction, and explainability in machine learning and computer vision.

The proposed system critically focuses on error detection, correction, and explainability on test or deployment scenarios where the data is unlabeled. Importantly, the system performs error analysis without requiring labeled data.

In some cases, a system may include: at least one memory configured to store instructions; and at least one processor executing the instructions to perform operations, the operations comprising: processing a test instance through a machine learning model to obtain a set of inferences; detecting errors in the set of inferences and/or the machine learning model by evaluating model confidence, class confusability, consistency in predictions, and similarity to labeled examples; automatically correcting the errors in the set of inferences and/or updating the machine learning model using auxiliary models, rule-based approaches, and/or fine-tuning; determining post-hoc explanations for the errors using feature importance analysis, prototype-based explanations, and contrastive explanations; and outputting the post-hoc explanations to a user.

In some cases, a computer-implemented method may include: processing a test instance through a machine learning model to obtain a set of inferences; detecting errors in the set of inferences and/or the machine learning model by evaluating model confidence, class confusability, consistency in predictions, and similarity to labeled examples; automatically correcting the errors in the set of inferences and/or updating the machine learning model using auxiliary models, rule-based approaches, and/or fine-tuning; determining post-hoc explanations for the errors using feature importance analysis, prototype-based explanations, and contrastive explanations; and outputting the post-hoc explanations to a user.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1A depicts an example environment for trust-aware error detection, correction, and explainability in machine learning and computer vision.

FIG. 1B depicts components of a machine learning platform server.

FIG. 1C depicts a workflow of a machine learning platform server and how a components of the machine learning platform server work with each other.

FIG. 2 depicts subcomponents of a machine learning platform server, and an approach where a user can adjust thresholds and conditions for selecting error samples.

FIG. 3 depicts subcomponents of a machine learning platform server, and an approach where the machine learning platform server can train a ML model using different criteria as features to predict if an example is an error case or not.

FIG. 4 depicts how to fix a ML model in real-time using multiple auxiliary models.

FIG. 5 depicts how to fix a ML model predictions in real-time using a rule-based system.

FIG. 6 depicts a workflow to update a ML model after a set of error cases have been identified.

FIG. 7 depicts explainability subcomponents of a machine learning platform server.

FIG. 8 depicts a flowchart of a method for trust-aware error detection, correction, and explainability in machine learning and computer vision.

FIG. 9 depicts an example system that may execute techniques presented herein.

### DETAILED DESCRIPTION

Generally, the present disclosure pertains to the field of machine learning and computer vision, specifically addressing the identification and correction of model mistakes, as well as providing intuitive explanations for model predictions. The disclosure focuses on enhancing trust and reliability in machine learning and computer vision systems by detecting errors, suggesting potential inaccuracies, and offering insights into model behaviour to facilitate improvements.

Systems and methods of the disclosure may provide a framework for being able to identify: (i) when the model is likely making a mistake (component 101), (ii) automatically correcting the model mistake (component 102), and (iii) an explanation of why the model may have made the mistake if it makes one (component 103).

In some cases, the framework may provide several notable advantages. By incorporating trust-aware error detection, users can be alerted to potential inaccuracies, minimizing reliance on faulty outputs and mitigating associated risks. The provision of intuitive explanations enhances user trust, empowering them to assess model behavior and make informed decisions. Furthermore, by offering insights into model mistakes and avenues for improvement, the framework may facilitate iterative enhancements, leading to more accurate and reliable machine learning and computer vision systems. Additionally, this may also allow for obtaining automatic evaluation of models without requiring a labeled test dataset. Traditionally, in machine learning problems, a way of evaluating the model is to use a labeled test set. However, in real-world tasks, there is often a distribution shift and a deployment scenario may change. Obtaining labeled test data for every new type of deployment scenario may be challenging and time consuming. In some cases, the framework may alleviate that challenge by performing auto-evaluation by using approaches discussed herein.

In some cases, the framework may address challenges associated with model mistakes, trust, and explainability in machine learning and computer vision. The framework may offer techniques for detecting erroneous predictions and alerts users when model outputs may be incorrect, instilling confidence and avoiding potential negative consequences. Furthermore, the framework may provide intuitive explanations, highlighting the factors influencing predictions and suggesting actionable insights for improving the model's accuracy and reliability.

To detect if the model is making mistakes, the framework may use a number of criteria (also referred to as attributes) including: (i) confidence of the model in making predictions (uncertainty), (ii) confusability of the model between classes, (iii) use of auxiliary models and approaches to determine if the model output is correct, and (iv) use of a labeled validation/evaluation set to determine errors and identify error examples based on similarity with incorrectly predicted instances. In some cases, the framework may propose approaches to fix the model including the use of auxiliary models, the use of pre-trained models and transfer learning, the use of rules and expert knowledge to guide and fix model errors, model calibration, and the like. In some cases, the framework may propose to give explanations as to why the model makes mistakes. For this, the framework may use feature importance analysis, attention mechanisms, or rule-based explanations to uncover the factors influencing the model's decisions. Additionally, the framework may find examples in the training data/validation data similar to a given test example and attempt to identify why the model might be mistaken (e.g., the given test example seems different from training examples or this test example belongs to a rare class or slice).

Unlike existing technologies that focus on isolated aspects of error detection or correction, the proposed system integrates all three critical components—detection, correction, and explainability—into a single, cohesive framework. This unified approach ensures that machine learning models are not only corrected but also transparent and trustworthy, significantly enhancing user confidence.

The system goes beyond mere error correction by providing detailed, post-hoc explanations for model decisions. Techniques like feature importance analysis, prototype-based explanations, and contrastive explanations are integrated into the framework to ensure that users understand the underlying causes of errors. This transparency is crucial for building trust in machine learning models, particularly in applications requiring high accountability.

The technical disclosure is particularly tailored for high-stakes environments such as autonomous vehicles, healthcare, and security systems, where errors can have significant consequences. The system's ability to dynamically adjust thresholds and provide domain-specific corrections and explanations distinguishes it from more generalized solutions.

A novel aspect of this disclosure is the integration of human expert feedback into the error detection and correction loop. This feature allows the system to continuously learn and improve, adapting to new data and scenarios in real-time. By incorporating human insights, the system bridges the gap between automated correction and expert-driven refinement, leading to more reliable and accurate models.

The system is designed to operate in real-time, making it suitable for applications where immediate correction is essential. Its architecture supports scalability across various machine learning tasks, from classification to object detection, ensuring broad applicability and robust performance in diverse environments.

Thus, methods and systems of the present disclosure may be improvements to computer technology and/or ML and computer vision.

### 1. Environment

The present disclosure pertains to systems and methods for enhancing the reliability and trustworthiness of machine learning and computer vision systems. More specifically, the disclosure provides a comprehensive framework that may be capable of identifying potential errors in a machine learning model's predictions, automatically correcting these errors, and providing intuitive explanations for the errors. This framework may be designed to operate in real-time and may be scalable across various machine learning tasks, making it suitable for a wide range of applications. The framework may also incorporate human expert feedback into the error detection and correction process, enabling continuous learning and improvement. The disclosure further provides techniques for post-hoc analysis of model errors, offering insights into the specific features or characteristics that led to the mistake. These techniques may include feature importance analysis, prototype-based explanations, and contrastive explanations. The disclosure may be particularly beneficial in high-stakes environments such as autonomous vehicles, healthcare, and security systems, where errors can have significant consequences.

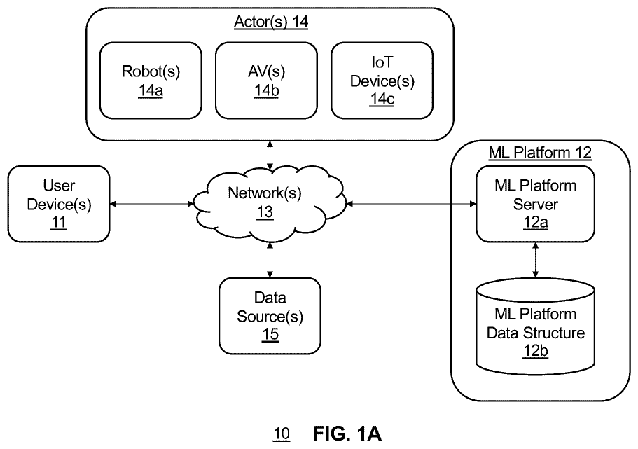

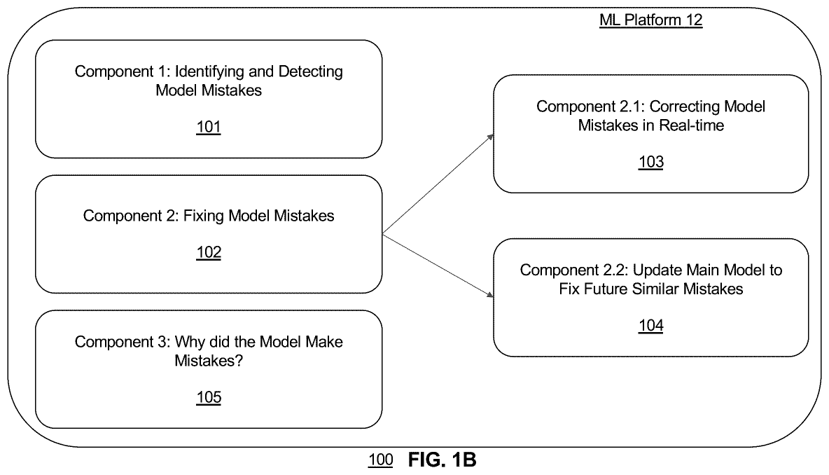

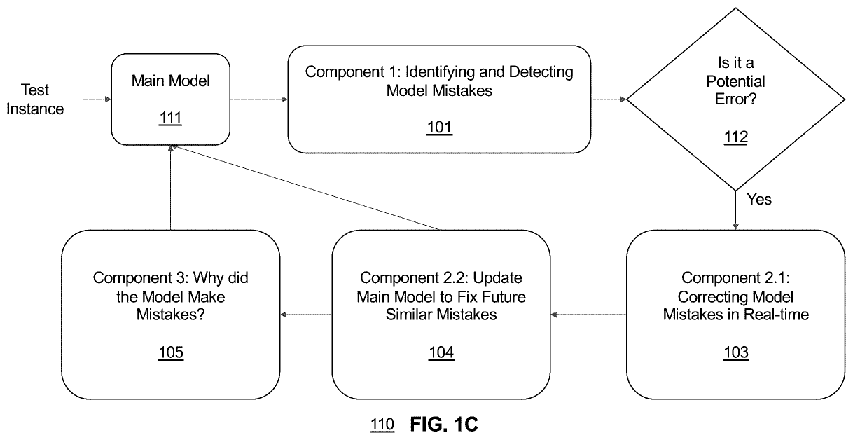

FIG. 1A depicts an example environment 10 for trust-aware error detection, correction, and explainability in machine learning and computer vision. The environment 10 may include user device(s) 11, network(s) 13, actor(s) 14 (such as robot(s) 14a, autonomous vehicle(s) 14b, and/or IoT device(s) 14c), a ML platform 12 (including, e.g., a ML platform server 12a and ML platform data structure 12b), and data source(s) 15 (collectively, “system”). The system may be configured to detect errors and correct errors, and these operations may be integrated into a cloud-based ML platform 12, allowing for scalable deployment and continuous updates. This may ensure that the system remains up-to-date with the latest data and model improvements. The system may also include at least one memory configured to store instructions and at least one processor executing the instructions to perform operations.

The user devices 11 may be connected to the network 13, allowing users to interact with the ML platform 12 and other components of the system. The user device(s) 11 may (hereinafter “user device 11” for ease of reference) may be a personal computing device, such as a cell phone, a tablet, a laptop, or a desktop computer. In some cases, the user device 11 may be an extended reality (XR) device, such as a virtual reality device, an argument reality device, a mixed reality device, and the like. In some cases, the user device 11 may be associated with a user (e.g., a customer or engineer of the ML platform 12). The user/engineer may have an account associated with the user device 105 that uniquely identifies the user/engineer (e.g., within the ML platform 12). Additional features of the user device 11 and interactions with other devices are described below.

The network(s) 13 may include one or more local networks, private networks, enterprise networks, public networks (such as the internet), cellular networks, and satellite networks, to connect the various devices in the environment 10. Generally, the various devices of the environment 10 may communicate over network(s) 13 using, e.g., network communication standards that connect endpoints corresponding to the various devices of the environment 10.

The actor(s) 14 (“actor 14” for ease of reference) may be any combination of one or more of: robot(s) 14a, autonomous vehicle(s) 14b, and/or IoT device(s) 14c. In some cases, the robot(s) 14a may include land (e.g., indoor or outdoor), air, or sea autonomous machines. In some cases, the AV(s) 14b may be a car, a truck, a trailer, a cart, a snowmobile, a tank, a bulldozer, a tractor, a van, a bus, a motorcycle, a scooter, or a steamroller. The IoT device(s) 14c may any internet connected device that performs actions in accordance with software. Generally, the actor(s) 14 may process input (e.g., sensor data such as from data source(s) 15, instructions from other actor(s), instructions from user devices 11, instructions from ML platform 12, and the like) and perform actions. In some cases, the actor(s) 14 may host ML models or receive inputs from other devices (e.g., ML platform 12) based on ML models hosted on those other devices. The ML models may identify aspects of the environment, make decisions about how to navigate or path plan through the environment, and make decisions about how to perform functions (e.g., physical actions or software functions) with respect to the environment (including physical and/or software features of the environment).

The ML platform server 12a may execute instructions to perform operations, such as processing data and executing machine learning algorithms. The ML platform data structure 12b may store relevant data and models. The ML platform 12 may generate, update, and/or host ML models for the environment 10. In some cases, the ML platform server 12a may coordinate data and/or instructions between various devices of the environment, such as the user device 11 and an actor 14. The ML platform server 12a may a computer, a server, a system of servers, and/or a cloud environment (e.g., using virtual machines and the like). The ML platform server 12a may also manage data stored and provided from the ML platform data structure 12b. The ML platform data structure 12b may store and manage relevant data for user device(s) 11, relevant data for actor(s) 14, data from data source(s) 15. The ML platform data structure 12b may include one or combinations of: a structured data store (e.g., a database), an unstructured data store (e.g., a data lake), files, and the like.

The data source(s) 15 may include relevant data feeds to the various user device(s) 11, users/engineers of the user device(s) 11, ML models, actor(s) 14 and the like. For instance, in some cases, the data source(s) 15 may include a map provider, a satellite image provider, weather data provider, and the like.

### 2. Components 100

FIG. 1B depicts components 100 of a machine learning platform 12. The features of FIG. 1B may apply to any of the features of FIGS. 1A, 1C, and 2-8. The components 100 of the machine learning platform 12 may describe a framework to achieve trust-aware error detection, correction, and explainability in machine learning and computer vision. In some cases, the platform incorporates mechanisms for identifying and detecting potential mistakes. In some cases, the platform, upon detection to a potential mistake (or error), may notify a user, raising awareness of potential inaccuracies and facilitating further investigation or alternative actions. Additionally, the platform may automatically attempt to correct model mistakes and provide analysis into why the model is making a mistake. In some cases, the platform may be applied to certain use cases in machine learning and computer vision, such as, (i) classification, (ii) object detection, (iii) regression, (iv) object tracking, and (v) natural language processing.

The ML platform 12 may include several interconnected components 100 that work together to improve machine learning model performance. The first component 101 may be responsible for identifying and detecting model mistakes. This component may serve as the initial stage in the error detection process. In some cases, the first component 101 may evaluate different aspects of model performance and data characteristics to identify potential errors in the model's predictions.

The second component 102 may focus on fixing model mistakes. It may be connected to two subcomponents: the first subcomponent 103 and the second subcomponent 104. The first subcomponent 103 may be designed for correcting model mistakes in real-time on unlabeled deployment data, allowing for immediate improvements. In some cases, the first subcomponent 103 may use higher complexity auxiliary models and ensembles, or rule-based approaches to correct the model's predictions. The second subcomponent 104 may be tasked with updating the main model to prevent similar mistakes in the future, enhancing long-term performance. In some cases, the second subcomponent 104 may use fine-tuning or transfer learning techniques to update the main model.

The third component 105 may be dedicated to analyzing why the model made mistakes. This component may provide insights into the reasons behind model errors, which can be used to further refine the model and prevent similar issues in the future. In some cases, the third component 105 may use feature importance analysis, prototype-based explanations, and contrastive explanations to provide a comprehensive understanding of the reasons behind the model's errors.

The components 100 are arranged in a logical flow within the ML platform 12. This arrangement provides a process where errors are first detected, then corrected, and finally analyzed to improve overall model performance. In some cases, the components 100 may operate in real-time, making them suitable for applications where immediate correction is essential. In other cases, the components 100 may operate in a batch processing mode, allowing for the accumulation of error cases before model updating.

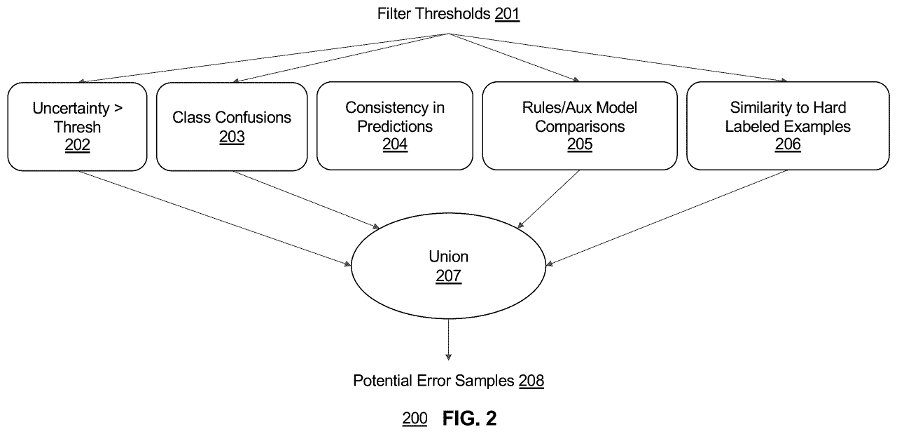

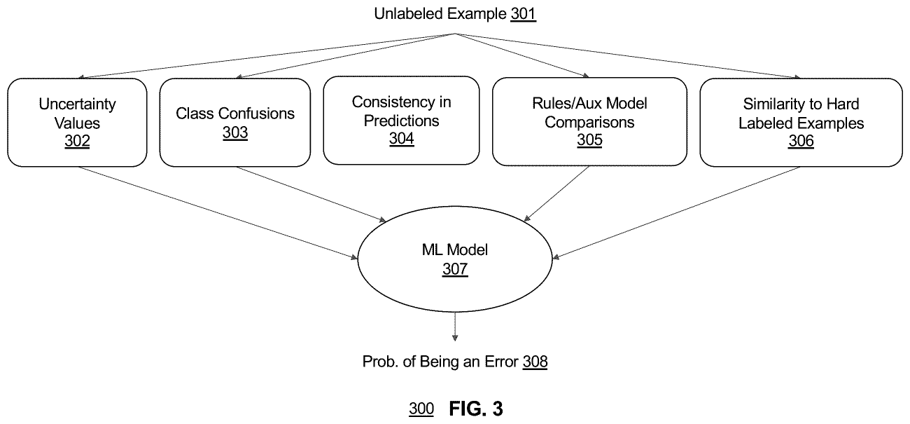

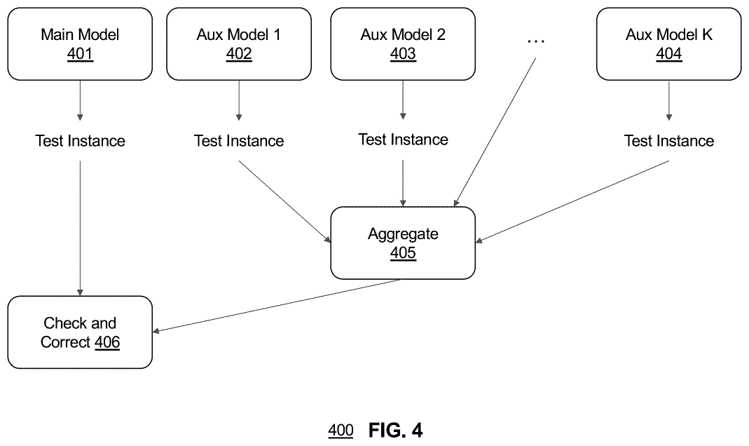

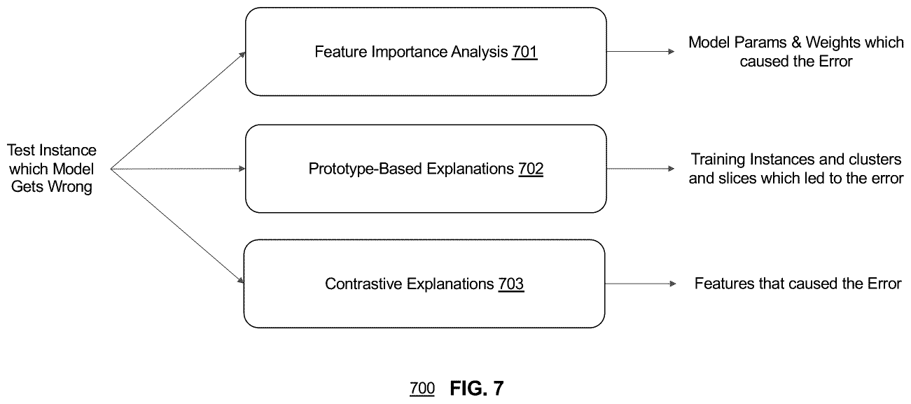

The components 100 may include three main components, including the first component 101 configured to identify and detect model mistakes (see, e.g., FIGS. 2 and 3); the second component 102 configured to fix model mistakes (see, e.g., FIGS. 4-6); and the third component 105 configured to provide explanations as to the cause of the mistake/error (see, e.g., FIG. 7), which can help a human user and data scientist fix the model mistake.

The second component 102 may include major subcomponents to perform different types of fixes. The second component 102 may include a first subcomponent 103 configured to correct model mistakes in real-time and a second subcomponent 104 configured to update a main model to fix future similar mistakes.

In some cases, the second component 102 may automatically fix model mistakes with a human in the loop. The platform may use one or more of three approaches for fixing model mistakes with a human in the loop: (i) using higher complexity auxiliary models and ensembles, (ii) using rule based approaches, and (iii) finetune and transfer learning on error cases. Approaches (i) and (ii) may be approaches for fixing model mistakes in real time, and approach (iii) may improve the model in a continuous manner so it can fix the same kind of mistakes in future.

The first subcomponent 103 may correct model mistakes in real-time. The platform may use two major approaches for correcting model mistakes in real-time. The first may use higher complexity auxiliary models and ensembles, and the second may use rule-based systems.

With respect to higher complexity auxiliary models and ensembles, in most typical real world applications, the platform (or its customers) may have resource constraints and the models need to be amenable to those resource constraints. These resource constrained models tend to underperform because of their lower complexity and size. Using first component 101, the platform may identify potential error cases and apply the higher complexity models or ensemble models. Building an ensemble of models can help improve performance in specific scenarios. By training multiple models with different architectures, or on different subsets of data, the platform may combine respective predictions to make a final decision. Ensemble methods can help mitigate errors by leveraging the diversity of models' predictions and potentially reducing the impact of mistakes made by individual models. If the base model is reasonably accurate (e.g., 70-80% accuracy), the platform may not require use of the higher complexity auxiliary model or the ensemble model (e.g., on known quality of data).

With respect to using rule based approaches, rule-based approaches may involve incorporating explicit rules or constraints into the model's decision-making process to address specific scenarios or cases where the model is making mistakes. These rules provide additional guidance and can act as corrective mechanisms to prevent or rectify errors based on known patterns or logical constraints.

In some cases, the rule based approaches may include expert knowledge/rule systems. The rule-based approaches often leverage expert knowledge or domain expertise to define rules that capture the specific conditions or patterns related to the problematic scenarios. Experts can provide insights into the relationships between input features and the desired output, allowing the formulation of rules that align with their expertise.

In some cases, the rule based approaches may include logical constraints. The rule-based approaches can impose logical constraints that reflect known relationships or constraints within the problem domain. These constraints can help guide the model's decision-making process and prevent it from making errors that violate the logical rules. By incorporating such constraints, the model's predictions are aligned with the logical expectations defined by the rules.

In some cases, the rule based approaches may include post-processing filters. The rule-based approaches can be applied as post-processing filters to the model's predictions. By defining rules that identify certain cases where the model is likely to make mistakes, one can modify or adjust the predictions based on these rules. For example, one can set thresholds or conditions that trigger further examination or alternative actions when the model's output falls within certain ranges or violates certain constraints.

Generally, rule-based approaches may offer interpretability and transparency, as the decision-making process of the model is explicitly defined by the rules. They can be particularly useful in domains where clear rules or constraints exist, or when domain experts possess valuable knowledge about the problem. By incorporating these rules, one can guide the model's behavior and mitigate errors in specific scenarios, leading to improved performance and increased reliability in those cases.

The second subcomponent 104 may update the main model to fix future similar mistakes. Using the first Component 101, the platform may detect potential model mistakes in real-time. Using either human expert labelers, and or rules/systems like those described above, the platform may incorporate a feedback loop to help fix the models. Experts (both humans and rules) can review the model's predictions, identify errors, and provide feedback on the mistaken instances (e.g., misclassifications). This feedback can be used to refine or update the existing rules or introduce new rules that address the specific mistakes observed. The iterative refinement process may help improve the model's performance and reduces errors in problematic scenarios. The second subcomponent 104 may use two ways to update the model: fine tuning and/or transfer learning.

With respect to fine-tuning, fine-tuning involves training the model on new or additional data that is specifically focused on the scenarios or cases where the model is making mistakes. By collecting more labeled data that represents those problematic instances and retraining the model with this targeted data, the platform may help the model learn and correct its errors in those specific cases. Fine-tuning is particularly effective when the mistakes occur in identifiable and specific scenarios.

With respect to transfer learning, transfer learning allows the platform to utilize knowledge learned from a pre-trained model and apply it to the problematic scenarios or cases. Instead of training from scratch, one can leverage a pre-trained model that has been trained on a related task or dataset. By fine-tuning or adapting the pre-trained model using the additional data related to the specific problematic cases, one can enable the model to generalize better and improve its performance in those scenarios.

### 3. Workflow 110

FIG. 1C depicts a workflow 110 of a machine learning platform 12 server and how a components of the machine learning platform server work with each other. The features of FIG. 1B may apply to any of the features of FIGS. 1A, 1B, and 2-8.

The workflow 110 illustrates the process of detecting, correcting, and analyzing model mistakes in a machine learning system. The process begins with a test instance being input into a main model 111. The main model 111 processes the test instance to generate a set of inferences. These inferences may include predictions, classifications, or inferences made by the main model 111 based on the input data.

The output from the main model 111 is then passed to a first component 101, which is responsible for identifying and detecting potential model mistakes. The first component 101 may evaluate the inferences from the main model 111 based on various criteria, such as model confidence, class confusability, consistency in predictions, and similarity to labeled examples. In some cases, the first component 101 may use a machine learning algorithm to analyze the inferences and identify potential errors.

Following the first component 101, the workflow 110 proceeds to a decision point represented by a potential error filter 112. This filter 112 determines if the output from the first component 101 indicates a potential error. If the answer is “Yes”, the process moves to a first subcomponent 103, which is designed to correct model mistakes in real-time.

The first subcomponent 103 may use various techniques to correct the identified errors, such as applying rule-based approaches, using auxiliary models, or fine-tuning the Main model 111. The corrected output from the first subcomponent 103 is then directed to a second subcomponent 104, which is responsible for updating the main model 111 to prevent similar mistakes in the future.

The second subcomponent 104 may use techniques such as transfer learning or fine-tuning to update the main model 111. The updated main model 111 may then be used to process future test instances, thereby improving the accuracy and reliability of the model's predictions.

After the second subcomponent 104, the process moves to a third component 105, which is dedicated to analyzing the reasons behind the model's errors. The third component 105 may use techniques such as feature importance analysis, prototype-based explanations, and contrastive explanations to provide insights into the causes of the errors.

The workflow 110 demonstrates a sequential process of error detection, correction, and analysis. It incorporates multiple components to improve the accuracy and performance of the Main model 111 over time. The process allows for real-time corrections and updates to prevent similar mistakes in the future, while also providing insights into the reasons behind the model's errors.

In some cases, the workflow 110 may be configured for error detection, correction, and explainability in unlabeled deployment data, operating without reliance on labeled ground truth during deployment. This may allow the system to adapt to new environments or data distributions, enhancing its flexibility and applicability in various machine learning tasks.

In some cases, the workflow 110 of the platform may start with a test instance (e.g., a set of data, labelled or non-labelled) being processed by the main model 111 (e.g., that which will be used by actor(s) 14 and the like). The main model 111 may output inferences/predictions and the first component 101 may identify and detect a model mistake from among the inferences/predictions for the set of data. At potential error filter 112, the platform may determine if the first component detected any mistakes and, if so, route the (potentially) erroneous mistakes to the first subcomponent 103, which may correct model mistakes in real-time. The platform may then route the (verified or corrected) prediction/inference to the second subcomponent 104 to update the main model 111 to fix future similar mistakes. In some cases, the platform may store or indicate relevant data associated with the mistake for future training or tuning. In this way, the second subcomponent 104 may update the main model 111 and/or provide data (e.g., the verified/corrected prediction/inference) to the third component 105. The third component 105 may process the relevant data to determine an explanation of why the model made the mistake(s). The third component 105 may then route the explanation to the main model 111 (e.g., for a user to view in association therewith).

Thus, the platform may detect, fix, and explain model mistakes, to enable users/data scientists to iteratively increase accuracy of ML models and understand limitations of the main model 111 and the like.

### 4. Component 1: Identifying and Detecting Mistakes by the Model

FIG. 2 depicts an error detection system that incorporates subcomponents of a machine learning platform server 12, and an approach where a user can adjust thresholds and conditions for selecting error samples. The features of FIG. 2 may apply to any of the features of FIGS. 1A, 1B, 1C and 3-8. FIG. 3 depicts subcomponents 300 of a machine learning platform server 12, and an approach where the machine learning platform server can train a ML model using different criteria as features to predict if an example is an error case or not. The features of FIG. 3 may apply to any of the features of FIGS. 1A, 1B, 1C, 2, and 4-8.

Referring to FIG. 2, the subcomponents 200 of the ML platform server 12 may illustrate a method for identifying potential errors in machine learning model outputs. The system 200 comprises filter thresholds 201 at the top level, which are used to evaluate different aspects of model performance and data characteristics.

The filter thresholds 201 are applied to five distinct components: uncertainty threshold 202, class confusions 203, consistency predictions 204, model comparisons 205, and labeled examples 206. These components represent different criteria for detecting potential errors in the model's predictions.

The uncertainty threshold 202 evaluates the model's confidence in its predictions. In some cases, the uncertainty threshold 202 may assess a probability associated with a prediction made by the machine learning model. Instances with low confidence may be identified as potential error cases.

Class confusions 203 assess the likelihood of the model misclassifying between similar classes. In some cases, the system may evaluate a margin between predicted class probabilities to determine a likelihood of the machine learning model confusing two or more classes.

Consistency predictions 204 examine the stability of the model's outputs across similar inputs. In some cases, the system may measure the consistency of the predictions of the machine learning model across similar or perturbed input instances. Variations in the predictions may indicate potential errors.

Model comparisons 205 involve comparing the main model's predictions with those of auxiliary models or rules. In some cases, the system may compare the test instance to the labeled examples from training data to identify potential inconsistencies or anomalies of the test instance.

Labeled examples 206 compare the model's outputs to known, correctly labeled data points. In some cases, the system may compare the test instance to the labeled examples from training data to identify potential inconsistencies or anomalies of the test instance.

The outputs from these five components feed into a union module 207. This union 207 aggregates the results from all the filtering criteria, combining the potential errors identified by each method.

The final output of the system is a set of potential error samples 208. These samples represent instances where the model's predictions are likely to be incorrect, as determined by one or more of the filtering criteria.

The error detection system 200 provides a comprehensive approach to identifying potential errors in machine learning model outputs by considering multiple aspects of model behavior and data characteristics. In some cases, the error detection system 200 may be configured to operate in real-time, making it suitable for applications where immediate error detection is essential. In other cases, the error detection system 200 may operate in a batch processing mode, allowing for the accumulation of error cases before model updating.

Referring to FIG. 3, the subcomponents 300 of the ML platform server 12 may illustrate an error detection system for machine learning models. The system processes an unlabeled example 301 through various analysis components to determine the probability of it being an error case. The system comprises five main analysis components: uncertainty values 302, class confusions 303, consistency predictions 304, model comparisons 305, and labeled examples 306. These components are connected to a ML model 307.

The unlabeled example 301 is input into each of the five analysis components. The uncertainty values 302 assess the model's confidence in its prediction. Class confusions 303 evaluate potential misclassifications. Consistency predictions 304 check for stability in the model's outputs. Model comparisons 305 contrast the main model's prediction with auxiliary models or rules. Labeled examples 306 compare the input to known, correctly labeled data.

The outputs from these five components feed into the ML model 307. This model processes the information from all analysis components to produce an error probability 308. The error probability 308 represents the likelihood that the unlabeled example 301 is an error case based on the combined analysis of all components.

In some cases, detecting errors includes processing attributes of the set of inferences and/or the machine learning model through a meta-machine learning model to predict whether the test instance is an error case. The meta-machine learning model is configured to combine error-indicating signals into a refined prediction. This approach allows for a comprehensive assessment of potential errors in machine learning predictions by integrating multiple error detection approaches.

In some aspects, the system diagram 300 may be configured to operate in real-time, making it suitable for applications where immediate error detection is essential. In other cases, the system diagram 300 may operate in a batch processing mode, allowing for the accumulation of error cases before model updating.

In some cases, the platform may attempt to identify and detect model errors without any ground truth label on the test example. The platform may use one or a combination of the following criteria: (i) confidence of the model predictions (202/302), (ii) confusability between classes (203/303), (iii) consistency of model predictions (204/304), (iv) using rules based on either human expertise on the domain or auxiliary models (205/305), and (v) using similarity to labeled train/test data instances & label preserving augmentations to identify errors (206/306).

Given the above criteria, the platform may use (at the same time, individually, or as cross-checks) two different approaches to identify and detect error samples in an unlabeled dataset. The first approach is where a user can manually set thresholds for each of the above criteria (if used), and the second approach is where using machine learning models can combine one or more of the signals of above criteria (if used) to predict if an unlabeled test example will be a mistake by the model or not. The disclosure describes each of these criteria below and then provides details of the two approaches of the platform to combine these criteria.

Confidence in Model Predictions (202/302): Model confidence or uncertainty can be measured in various ways. In the case of classification, the platform may use soft-max probabilities and entropy. The softmax function produces probabilities for each class in a multi-class classification problem. Uncertainty may be calculated by examining the probabilities associated with the predicted class. Lower probabilities indicate higher uncertainty. Another metric is entropy, which measures the uncertainty or randomness in the predicted class probabilities. High entropy values imply higher uncertainty. The entropy can be computed using the predicted probability distribution over classes, such as by applying the Shannon entropy formula. Uncertainty can be computed for regression using prediction intervals. Prediction intervals may define a range within which the true value is likely to fall. By considering the variance or standard deviation of the predicted values, a prediction interval can be computed to quantify uncertainty. For example, techniques like quantile regression or bootstrapping can be used. In the case of object detection, the platform may compute uncertainty based on the class probabilities for each bounding box, and by taking the confidence intervals for the bounding box.

Class Confusability (203/303): In the case of classification and object detection, class confusability can be a useful measure to capture possible error cases. One such metric is margin, which refers to the difference between the predicted scores or probabilities assigned to the correct class and the scores or probabilities assigned to the other classes. It indicates the level of confidence or certainty that the model has in its prediction. A larger margin implies a higher confidence in the prediction, while a smaller margin suggests uncertainty or potential confusion between classes. In addition, we can also use the similarity to class prototypes. If we have access to prototypical examples or centroids representing each class, one can measure the similarity of unlabeled instances to these prototypes. Instances that are equidistant or similar to multiple prototypes indicate higher class confusability, as they may exhibit characteristics shared by different classes.

Consistency of Model Predictions (204/304): Consistency measures aim to quantify the stability or robustness of the model's predictions across different runs or perturbations of the data. These methods analyze how much the model's predictions change when the input is slightly modified or when small perturbations are applied. Higher consistency indicates lower “confusability” as the model consistently produces similar outputs for similar inputs, even in the absence of ground truth labels. One aspect of measuring consistency involves evaluating how the model's predictions respond to perturbations or variations in the input data. By introducing small changes to the input instances, such as adding noise, flipping pixels, or altering minor details, one can observe if the model's predictions remain consistent or change significantly. Consistency can also be assessed by perturbing the model itself, such as through dropout or other stochastic techniques. By sampling predictions from multiple runs of the same model or applying dropout during inference, the platform may evaluate if the model consistently produces similar outputs across different runs. Using this, the platform may produce a consistency score for each data instance and identify instances with low consistency as potential error samples.

Rules and Auxiliary Models (205/305): In certain domains like natural language processing and text classification, domain experts can write rules (e.g., the presence or absence of words, capitalization of words or the lack of it, length of the document, and so on). These rules may provide pseudo labels. For example, in the case of “spam” email detection, the platform may use rules about the presence of absence of certain words like “Free” or “Viagra” which are more likely to occur in spam emails. The platform may then combine multiple rules and thereby obtain pseudo labels. If the pseudo labels do not match with the model predictions, this might indicate a signal that something is potentially wrong. Additionally, the platform may also use auxiliary models which may be from a different model family or a slightly different training dataset (with the same label set). We can then measure consistency between the labels and predictions obtained from the auxiliary model and the main model and in case there is a lack of consistency, this might indicate that something is wrong with that specific example. Finally, the platform may use an auxiliary approach to determine if the model is correct. For example, in the case of object tracking in video analytics, to determine if the object tracking is being done correctly, we can use person re-identification models to determine if the same object that the user had targeted is being tracked or if there is an identity switch.

Similarity to Labeled Samples (206/306): As a first step, the platform may perform label preserving data augmentations to increase the diversity and representativeness of the labeled data set. The platform may then find nearest neighbors to the labeled data set from the unlabeled test set of examples and in that way identify potential error samples. If a given test example has a high similarity to a specific labeled data instance that we know the model incorrectly classified, it is likely that this test example will also be a mistake.

Thus, each of the criteria may provide different signals indicating potential errors based on different modalities or sources indicating an error.

In the first approach, the platform may detect errors using filters and thresholds for each of the used criteria. In some cases, the platform may provide a graphical user interface so that the user may make such selections/adjustments. In some cases, the platform may be configured to receive application programming interface (API) calls to make such selections/adjustments. In some cases, the user may also select if an error example must have at least a certain subset of criteria satisfied to be able to be called an “error” example. Thus, this approach may enable the user to set thresholds and conditions for filtering for components 202-206, and also how many conditions need to be satisfied to be an error example.

In the second approach, the platform may detect errors using a ML Model 307. In some cases, the platform may obtain a labeled set of data instances (e.g., from the first approach, including some data instances of errors and some data instances of not erroneous), the platform may train a ML model on that labeled set and use features like the model confidence (probability, entropy), confusability, model consistency, and so on (components 302-306) as feature vectors to the ML model 307. The ML model 307 may use model families like decision trees, neural networks, or random forests to predict if a given test example will be an error or not (308) after it has been trained on the labeled set of data instances.

### 5. Component 2: Correcting Model Mistakes

### 5.A. Workflow 400

FIG. 4 depicts a workflow 400 for fixing a model mistake in real-time using multiple auxiliary models. The features of FIG. 4 may apply to any of the features of FIGS. 1A, 1B, 1C, 2-3, and 5-8.

The workflow 400 illustrates a system for error detection and correction in a machine learning model. The system comprises a main model 401 and multiple auxiliary models, including auxiliary model 402, auxiliary model 403, and auxiliary model 404. Each model processes a test instance independently, generating a set of inferences based on the input data.

In some cases, the auxiliary models 402, 403, and 404 may be higher complexity models compared to the main model 401. These auxiliary models may be trained on different architectures or data subsets, allowing them to capture a wider range of patterns and relationships in the data. The diversity of the auxiliary models may enhance the robustness of the system, as each model may excel in different scenarios or aspects of the task.

The outputs from the auxiliary models 402, 403, and 404 are connected to an aggregation module 405. This module 405 receives the outputs from all models and aggregates the information. The aggregation module 405 may use various techniques to combine the outputs, such as averaging, voting, or more complex methods like stacking or boosting. The aggregated output represents a consensus prediction from all models, which may be more accurate and reliable than the predictions of individual models.

The system also includes a correction module 406, labeled as “Check and Correct” in the diagram. This module 406 receives input directly from the main model 401 and from the aggregation module 405. The correction module 406 is responsible for checking and potentially correcting the output of the main model 401 based on the aggregated information from all models.

In some cases, the correction module 406 may use a rule-based approach to correct the predictions of the main model 401. These rules may be based on domain-specific knowledge or logical constraints, providing additional guidance to the model's decision-making process. The rules may also be dynamically adjusted based on the specific type of error detected, optimizing the correction process.

In other cases, the correction module 406 may use the auxiliary models 402, 403, and 404 to correct the predictions of the main model 401. The system may automatically select the most suitable auxiliary model based on the specific type of error detected. This selection may be based on a comparison of the main model's output with the outputs of the auxiliary models, identifying the auxiliary model that provides the most accurate prediction for the given test instance.

The workflow 400 shows a flow of information from the models to the aggregation module 405 and then to the correction module 406. This structure allows for comparison and integration of multiple model outputs to improve the accuracy and reliability of the final result. The workflow 400 demonstrates a comprehensive approach to error detection and correction in machine learning models, integrating multiple models and techniques to enhance model performance.

Workflow 400 may depict an approach for fixing model mistakes using (multiple) auxiliary models and ensembles. In some cases, the platform may generate multiple auxiliary models as ensembles (402-404). In some cases, the platform may use approaches like bagging or boosting. In some cases, the platform may use higher complexity or higher capacity models compared to the main model 401. In some cases, the platform may then perform inference on a test instance, and then aggregate the inferences from auxiliary models (405). In some cases, this may ensure that the platform reduces the variance of the prediction and make it less likely to overfit. In some cases, the platform may then compare aggregated inference to the inference of the main model (406) and correct the model prediction if there is a significant difference between the ensemble model prediction and the prediction from the main model.

### 5.B. Workflow 500

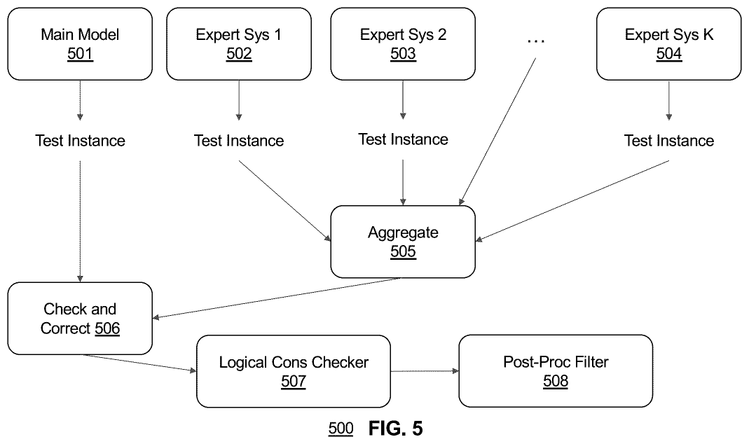

FIG. 5 depicts a workflow 500 for fixing a ML model predictions in real-time using a rule-based system. The features of FIG. 5 may apply to any of the features of FIGS. 1A, 1B, 1C, 2-4, and 6-8.

The workflow 500 illustrates a system for processing and correcting test instances using multiple models and expert systems. The workflow 500 includes a main model 501, multiple expert systems (502, 503, 504), an aggregator module 505, a checker corrector module 506, a logical constraint checker module 507, and a post-processing filter module 508.

The main model 501 and expert systems 1-K (502, 503, 504) each process a test instance independently. The outputs from the expert systems 1-K (502, 503, 504) are then fed into the aggregator module 505, which combines the results from all the models. This aggregation process may enhance the robustness and accuracy of the system by leveraging the diverse predictions from multiple models.

The output from the main model 501 and the aggregated output from the aggregator module 505 are both sent to the checker corrector module 506. This module checks for discrepancies between the main model's output and the aggregated expert systems' output, and may correct the main model's output if necessary. In some cases, the checker corrector module 506 may use rule-based approaches to correct the predictions of the main model 501. These rules may be based on domain-specific knowledge or logical constraints, providing additional guidance to the model's decision-making process.

The checker corrector module 506 then sends its output to the logical constraint checker module 507. This module applies logical constraints to ensure the output adheres to predefined rules or conditions. These logical constraints may be based on domain-specific knowledge, providing additional guidance to the model's decision-making process and ensuring that the output is consistent with known patterns or relationships in the data.

Finally, the output from the logical constraint checker module 507 is passed through the post-processing filter module 508. This module may perform additional refinement or filtering of the results before producing the final output of the workflow. The post-processing filter module 508 may use various techniques to refine the results, such as removing outliers, smoothing the predictions, or applying domain-specific filters.

The workflow 500 demonstrates a multi-stage process for enhancing the accuracy and reliability of model predictions by incorporating expert systems, aggregation, logical constraints, and post-processing steps. This comprehensive approach allows for real-time corrections and updates to prevent similar mistakes in the future, while also providing insights into the reasons behind the model's errors. In some cases, the workflow 500 may be configured to operate in real-time, making it suitable for applications where immediate error detection and correction are essential. In other cases, the workflow 500 may operate in a batch processing mode, allowing for the accumulation of error cases before model updating.

Workflow 500 may depict the workflow of first subcomponent 103. The first part is similar to the workflow 400. The platform may have K different expert systems 502-504 that can either be defined-rules (e.g., from humans, also called labeling functions) or ML models (e.g., auxiliary models 402-404, as in FIG. 4). The platform may obtain predictions from the expert systems 502-504, and then the platform may aggregate them (505). Once the platform obtains the aggregated predictions, the platform may check with the predictions of the main model (individually, or in the aggregate) and correct mistakes, if any.

If there are no expert systems 502-504 or auxiliary models 402-404, workflow 500 may be omitted. The final (verified or corrected) predictions are then passed through the logical constraint checker (module 507) followed by a post-processing filter (module 508). In some cases, the workflow 500 encompasses the workflow 400. In some cases, the workflow 500 is separate or in addition to workflow 400.

### 5.C. Workflow 600

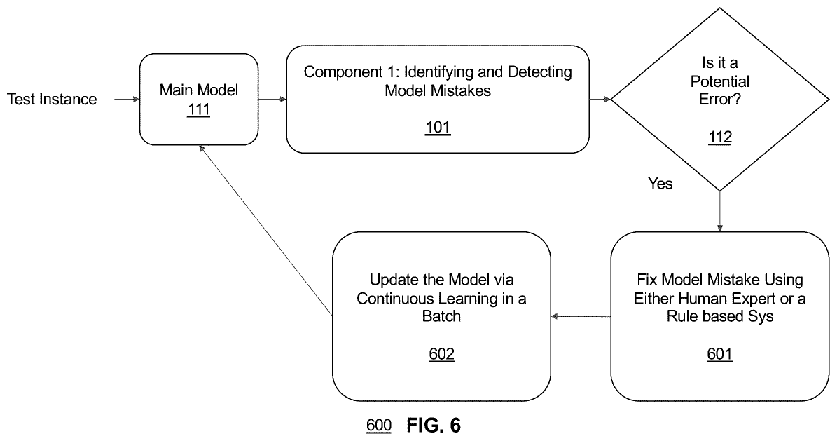

FIG. 6 depicts a workflow 600 to update a ML model after a set of error cases have been identified. The features of FIG. 6 may apply to any of the features of FIGS. 1A, 1B, 1C, 2-5, and 7-8.

The workflow 600 may illustrate a process for detecting and correcting errors in a machine learning model. The process begins with a test instance being input into a Main model 111. The Main model 111 processes the test instance to generate a set of inferences. These inferences may include predictions or classifications made by the Main model 111 based on the input data.

The output from the Main model 111 is then passed to a first component 101, which is responsible for identifying and detecting potential model mistakes. The first component 101 may evaluate the inferences from the Main model 111 based on various criteria, such as model confidence, class confusability, consistency in predictions, and similarity to labeled examples. In some cases, the first component 101 may use a machine learning algorithm to analyze the inferences and identify potential errors.

Following the first component 101, the workflow 600 proceeds to a decision point represented by a potential error filter 112. This filter 112 determines if the output from the first component 101 indicates a potential error. If the answer is “Yes”, the process moves to a fixer module 601, which is designed to correct model mistakes in real-time.

The fixer module 601 may use various techniques to correct the identified errors, such as applying rule-based approaches, using auxiliary models, or fine-tuning the Main model 111. The corrected output from the fixer module 601 is then directed to an updater module 602, which is responsible for updating the Main model 111 to prevent similar mistakes in the future.

The updater module 602 may use techniques such as transfer learning or fine-tuning to update the Main model 111. The updated Main model 111 may then be used to process future test instances, thereby improving the accuracy and reliability of the model's predictions.

In some cases, the updater module 602 may retrain the Main model 111 on identified error cases using a fine-tuning process and/or a transfer learning process. The fine-tuning process may adjust parameters of the Main model 111 on a subset of data that highlights weaknesses of the Main model 111. The transfer learning process may allow the system to adapt knowledge from pre-trained models to correct a behavior of the Main model 111.

The workflow 600 demonstrates a cyclical process of error detection, correction, and model updating. It incorporates both automated components and potential human intervention to improve the accuracy and performance of the Main model 111 over time. The process allows for real-time corrections and updates to prevent similar mistakes in the future, while also providing insights into the reasons behind the model's errors.

In some aspects, the workflow 600 may include a feedback loop, wherein the errors are used to continually improve error detection. The system may incorporate newly detected errors into a training process to enhance future error detection accuracy. This feedback loop may allow the system to continuously learn and improve, adapting to new data and scenarios in real-time.

Workflow 600 may depict the workflow of second subcomponent 104. Given a test example, the platform first identifies if it is a potential error example using the first component 101. If it is an error sample, the platform may fix the model mistake using a human labeler or a rule based system (601, such as by using the first subcomponent 103). The platform may then update the model using fine-tuning or transfer learning (602), and update the model in the end. Note that it may not make sense to update the model every time an error case is found. Rather, the platform may update the model after a batch of error cases have been found and the batch of error cases have been relabeled.

### 6. Component 3: Explaining Model Mistakes

### 6.A. Workflow 700

FIG. 7 depicts explainability subcomponents 700 of a machine learning platform server. The features of FIG. 7 may apply to any of the features of FIGS. 1A, 1B, 1C, 2-6, and 8.

The explainability subcomponents 700 of a machine learning platform server may illustrate an explainability system for analyzing errors in machine learning models. The explainability subcomponents 700 comprises three main components: a feature importance analysis module 701, a prototype-based explanations module 702, and a contrastive explanations module 703. These components are designed to provide detailed, post-hoc explanations for the errors identified by the machine learning model.

The feature importance analysis module 701 is responsible for identifying the influential features that contributed to an erroneous prediction of the machine learning model. This module may analyze the model parameters and weights to determine which features had the most significant influence on the model's decision. The feature importance analysis module 701 may use various techniques to assess feature importance, such as permutation importance, SHAP values, and LIME. Permutation importance measures the decrease in model performance when the values of a particular feature are randomly shuffled. SHAP values provide a unified measure of feature importance, attributing the contribution of each feature to the model's predictions based on cooperative game theory. LIME provides explanations for individual predictions by training a local interpretable model around the instance of interest.

The prototype-based explanations module 702 is designed to analyze the test instance in relation to the training data. This module identifies training instances, clusters, and data slices that may have influenced the model's erroneous output. By comparing the test instance with similar examples from the training data, the prototype-based explanations module 702 can provide insights into how the model's training data relates to the error. This analysis can help identify specific patterns or clusters that the model may have misinterpreted, leading to the error.

The contrastive explanations module 703 focuses on identifying specific features of the test instance that caused the error. This module compares the misclassified instance with correctly classified instances and identifies specific features or characteristics that led to the misclassification. By highlighting the discriminative features that influenced the model's decision, the contrastive explanations module 703 provides a detailed understanding of the reasons behind the model's errors.

In some cases, the explainability system 700 may be configured to operate in real-time, making it suitable for applications where immediate error explanation is essential. In other cases, the explainability system 700 may operate in a batch processing mode, allowing for the accumulation of error cases before model updating. The explainability system 700 provides a comprehensive approach to error analysis in machine learning models, integrating multiple analysis techniques to enhance model transparency and trustworthiness.

The explainability subcomponents 700 may provide post-hoc analysis on why a model made a mistake. The explainability subcomponents 700 may be subcomponents of the third component 105.

The third component 105/explainability subcomponents 700 may use one or more approaches for post-hoc analysis on why the model made a particular mistake. Generally, the explainability subcomponents 700 may provide post-hoc analysis at three levels. The first level is the feature importance analysis module 701. The feature importance analysis module 701 may examine model parameters and weights of the model that might have caused the error. The feature importance analysis module 701 may determine that the model overweights or underweights certain features which may cause errors. The second level is the prototype-based explanations module 702. The prototype-based explanations module 702 may find training instances, slices, and clusters/classes that led to the error. The prototype-based explanations module 702 may help in determining if certain classes or slices are substantially under-represented in the dataset (e.g., using a thresholding or relative size metric) and the platform should boost examples of those classes or slices to fix the model errors. The third level is the contrastive explanations module 703. The contrastive explanations module 703 may provide data with respect to discriminative factors that influenced the model's predictions.

### 6.B. Feature Importance Analysis Module 701

Conducting feature importance analysis can help identify the model parameters and weights that had the most significant influence on the model's decision. By examining the importance of each feature, the platform can determine which features played a significant role in the mistaken prediction. Feature importance analysis may use model agnostic approaches and/or model specific approaches.

With respect to model agnostic approaches, the platform may use one or combinations: permutation importance, SHAP (Shapley Additive Explanations), or LIME (Local Interpretable Model-Agnostic Explanations).

Permutation importance measures the feature importance by evaluating the performance drop of the model when a feature's values are randomly permuted. The platform may assess how much the model's accuracy or evaluation metric decreases when the feature's values are shuffled (e.g., adjusted). A greater drop in performance indicates that the feature has higher importance in the model's decision-making process.

SHAP values assign the contribution of each feature to the model's predictions based on cooperative game theory. The platform may compute an average marginal contribution of each feature by considering all possible permutations of features. SHAP values provide a unified measure of feature importance and the platform may determine insights into the impact of each feature on the model's predictions.

LIME may provide explanations for individual predictions by training a local interpretable model around the instance of interest. The platform may assess the importance of features by evaluating their influence on the local model's predictions. By approximating the behavior of the global model, locally, LIME determines the features that contributed most to the specific prediction.

With respect to model-specific approaches, the platform may use one or combinations of: feature importance in tree-based models or magnitude in linear models.

Tree-based models, such as decision trees and random forests, offer built-in methods for calculating feature importance. These models evaluate how much each feature contributes to the overall reduction in impurity or information gain in the tree. The importance of a feature is computed by summing up the feature's contribution across all trees in the ensemble.

In linear models, magnitude of coefficients indicates an importance of each feature. Larger magnitude coefficients suggest a stronger influence of the corresponding feature on the model's predictions. Standardized or normalized coefficients can be used to compare the relative importance of features when their scales differ.

Feature importance analysis may provide data into the relative importance of features in the model's decision-making process. By identifying the features with higher importance, the platform can gain a better understanding of which aspects of the data the model relies on most for its predictions. This analysis helps explain why the model made a mistake and which features (e.g., by ranking or clustering) might have contributed to the erroneous prediction.

### 6.C. Prototype-Based Explanations Module 702

Prototype-based explanations involve identifying representative examples or prototypes from the training data that are similar to the misclassified example. By analyzing the prototypes and their corresponding labels, the platform can provide data into how the model might have generalized incorrectly. Prototype-based explanations help identify specific patterns or clusters that the model may have misinterpreted.

The platform may perform prototype selection. Prototype selection may involve identifying subsets of instances from the training data that are representative of different classes or categories. The subsets typically include instances that are well-separated from each other and exhibit distinct characteristics, while instances within a subset for a class or category are near each other or exhibit similar characteristics. Prototype selection may be done using K-means clustering, density-based clustering, or facility location based submodular selection.

Once a prototype set is established, the platform may determine a similarity between the misclassified instance and prototypes of the prototype set. The platform may determine a similarity using similarity metrics like Euclidean distance, cosine similarity, or Mahalanobis distance, to measure the similarity between the feature representations of the misclassified instance and the prototypes. By quantifying the similarity, the platform may identify similar prototypes to the misclassified instance (e.g., ranked order of similarity, above a threshold similarity, and the like).

The platform may examine the prototypes that are similar to the misclassified instance, thereby determining data into the characteristics or features that led the model to make the mistake. The platform may analyze shared attributes, patterns, or class labels of these prototypes to understand how the model might have incorrectly generalized based on those characteristics. The platform may look for any commonalities or discrepancies that could explain the mistaken prediction.

The platform may visualize the prototypes with the misclassified instance (e.g., via a graphical user interface), thereby aiding a user in understanding the model's decision. By visually comparing the misclassified instance with the prototypes, the platform/user can identify similarities and differences in the relevant features. This visualization helps explain why the model might have misclassified the instance and provides intuitive insights into the specific attributes or patterns that contributed to the error.

### 6.D. Contrastive Explanations Module 703

Contrastive explanations involve comparing the features of the misclassified example with those of similar correctly classified examples. By determining the differences between the misclassified example and its closest correct counterparts, the platform may determine the specific features or characteristics that led to the mistake. Contrastive explanations provide valuable insights into discriminative factors that may influence the model's predictions.

The platform may use the following step-by-step analysis explain why the model made a mistake.

(1) Selecting Similar Correct Instances: The first step in contrastive explanations is for the platform to identify correctly classified instances that are similar to the misclassified instance. Similarity can be measured using various metrics such as Euclidean distance, cosine similarity, or Mahalanobis distance. These instances should belong to the correct class and have feature representations that are close to the misclassified instance. The platform can also use the submodular mutual information functions for this.

(2) Feature Comparison: Once the similar correct instances are identified, the next step is for the platform to compare the features of the misclassified instance with those of the correct instances. The platform may analyze the differences in feature values, distributions, or patterns between the misclassified instance and its correct counterparts. The platform may look for consistent discrepancies or variations that could explain the misclassification.

(3) Differentiating Features: the platform may next identify the features that play a significant role in distinguishing the misclassified instance from the correct instances. These differentiating features are likely to have had a significant impact on the model's decision. By understanding the importance of these features, the platform can determine insights into why the model misclassified the instance and which attributes or patterns misled the model.

(4) Visualizing Differences: Visualization techniques can be used to highlight the differences between the misclassified instance and the correct instances. For instance, the platform may visualize the feature distributions, plots, or charts that emphasize the discrepancies in the relevant features, e.g., to the user. This visual comparison provides a clear understanding of the specific characteristics that differentiate the misclassified instance from the correctly classified instances.

(5) Explanation and Insights: Based on the identified differences and their importance, the platform can provide an explanation for the misclassification. The platform may explain how the specific features or patterns misled the model and led to an incorrect prediction. These contrastive explanations offer insights into why the model made the mistake and provide interpretable reasons for the misclassification.

### 7. Example Flowchart

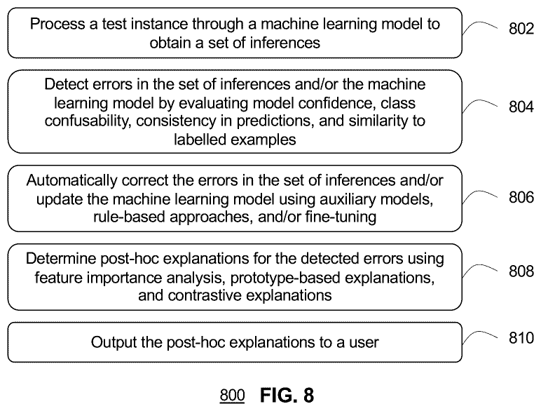

FIG. 8, the flowchart 800 illustrates a process for error detection, correction, and explanation in machine learning models. The process begins at block 802, where a test instance is processed through a machine learning model to obtain a set of inferences. These inferences may include predictions or classifications made by the machine learning model based on the input data.

The flowchart 800 then proceeds to block 804, which involves detecting errors in the set of inferences and/or the machine learning model. This detection may be performed by evaluating model confidence, class confusability, consistency in predictions, and similarity to labeled examples. In some cases, the error detection may be performed by a first component 101, which may use a machine learning algorithm to analyze the inferences and identify potential errors.

Following error detection, block 806 shows the automatic correction of errors in the set of inferences and/or updating of the machine learning model. This correction may be performed by a second component 102, which may use various techniques to correct the identified errors, such as applying rule-based approaches, using auxiliary models, or fine-tuning the machine learning model. The corrected output from the second component 102 may then be directed to a third component 105, which is responsible for analyzing the reasons behind the model's errors.

Block 808 represents the determination of post-hoc explanations for the detected errors. This step may be performed by an explainability system 700, which may use techniques such as feature importance analysis, prototype-based explanations, and contrastive explanations to provide insights into the causes of the errors.

The final step in the flowchart 800 is block 810, where the post-hoc explanations are output to a user. This step allows for the communication of the error analysis results to the end-user, enhancing the transparency and trustworthiness of the machine learning model. The user may use these explanations to understand the reasons behind the model's errors and make informed decisions based on the provided insights.

In some aspects, the flowchart 800 may be configured to operate in real-time, making it suitable for applications where immediate error detection, correction, and explanation are essential. In other cases, the flowchart 800 may operate in a batch processing mode, allowing for the accumulation of error cases before model updating. The flowchart 800 provides a comprehensive approach to error handling in machine learning models, integrating multiple stages of error detection, correction, and explanation to enhance model performance and user trust.

In some aspects, the operations of the system may be applied across various domains of machine learning and artificial intelligence. For instance, in the domain of classification, the system may be used to assign an input to one of several predefined categories. The system may detect errors in the classification process, such as misclassifications or incorrect category assignments, and correct these errors using auxiliary models, rule-based approaches, or fine-tuning. The system may also provide post-hoc explanations for the errors, helping users understand the reasons behind the misclassifications and how they were corrected.

In the domain of regression, the system may be used to predict a continuous value based on input data. The system may detect errors in the regression predictions, such as underestimations or overestimations, and correct these errors using similar techniques. The system may also provide post-hoc explanations for the errors, helping users understand the factors that influenced the inaccurate predictions and how they were corrected.

In the domain of object detection, the system may be used to identify and localize objects within an image or video. The system may detect errors in the object detection process, such as missed detections or incorrect localizations, and correct these errors using auxiliary models, rule-based approaches, or fine-tuning. The system may also provide post-hoc explanations for the errors, helping users understand the reasons behind the missed detections or incorrect localizations and how they were corrected.

In the domain of object tracking, the system may be used to follow an object across frames in a video sequence. The system may detect errors in the object tracking process, such as lost tracks or incorrect track continuations, and correct these errors using auxiliary models, rule-based approaches, or fine-tuning. The system may also provide post-hoc explanations for the errors, helping users understand the reasons behind the lost tracks or incorrect track continuations and how they were corrected.

In the domain of natural language processing, the system may be used to perform tasks involving analysis and generation of human language. The system may detect errors in the natural language processing tasks, such as incorrect word predictions or incorrect sentence structures, and correct these errors using auxiliary models, rule-based approaches, or fine-tuning. The system may also provide post-hoc explanations for the errors, helping users understand the reasons behind the incorrect word predictions or incorrect sentence structures and how they were corrected.

In each of these domains, the system may operate without reliance on labeled ground truth during deployment, detecting errors based on model uncertainty, class confusability, and other attributes, and correcting the errors using auxiliary models, rule-based approaches, and updating the machine learning model in real-time or batch processing to adapt to new environments or data distributions. The system may also incorporate newly detected errors into a training process to enhance future error detection accuracy, allowing the system to continuously learn and improve, adapting to new data and scenarios in real-time.

### 8. Use Cases

In some cases, the platform may be used in the following descriptions. It should be noted that these are not limiting but merely exemplary.

Use-Case 1—Classification: In the case of classification, the platform may use some or all of the criteria/attributes listed herein. The user may set thresholds for the various criteria above (entropy, confusability, consistency, and similarity to error samples), and based on these thresholds, the platform may alert the user about (potentially) incorrect model predictions. Additionally, the platform may also provide the option for the user to use a meta-ML model. An advantage of the meta-ML model is that the user does not need to tune any of the thresholds.

Use-Case 2—Regression: In the case of regression, the platform may use model uncertainty, consistency in model predictions, and auxiliary models to determine if the model will have a high error on a given test sample. The user may set thresholds for the above criteria and the platform will output potential error cases. In addition, the platform may also train a regression ML model which can predict the mean squared error (MSE) or mean absolute error (MAE), given the metrics like the model confidence, and consistency, and match with auxiliary models. The platform can also use nearest neighbor regression to predict these metrics given a labeled dataset with model predictions.

Use-Case 3—Object Detection: For object detection, the platform may use class confusability, entropy, consistency, and similarity to error samples, to alert the user on incorrect classes for the bounding boxes. The platform may, additionally, use auxiliary models and region proposal networks to determine errors in the bounding boxes themselves.

Use-Case 4—Object Tracking: In the case of object tracking, the tracking algorithms make two kinds of mistakes. The first kind of mistake is where a tracker fails to track the object and loses the object. It is generally easier to detect the first case because, if the tracker loses the object, the tracker will stop tracking and return an empty object list (or a list of different length). However, this could also be possible in the case where the object leaves the field of view. To really determine if the object is lost and not outside the field of view, the platform may use an object re-identification algorithm to detect if the object is still present in the field of view, thereby concluding whether the object is lost or is outside the field of view. The first kind of mistake is that of identity switch. To determine identity switch, the platform may compare the features of the tracked object with previous features of the known object when the platform/user had initialized the tracking. If the features match, the platform may determine it is the same object. Alternatively, if there is no match in the features, we can conclude that there is not an identity switch.

Use-Case 5—Natural Language Processing: In the case of natural language processing (NLP), consider a task like spam classification as an example. In this case, the platform can store and apply rules based on the presence of absence of certain words, the sender of the email or sms, the length of the email or sms, and so on. The platform may then use a rule aggregation framework to generate an approximate label which the platform will then compare to the model output. The platform may use this data to provide some possible indications into scenarios where the model may make a mistake. For example, if an email contains words that regularly appear in spam emails like “FREE” (in capital), the rule aggregation approach can predict it to be spam while the ML model may fail to classify it as spam, in which case the platform may determine that there is something wrong in the model output. An input to the rule aggregation framework can also be another ML model.

### 9. Computer System

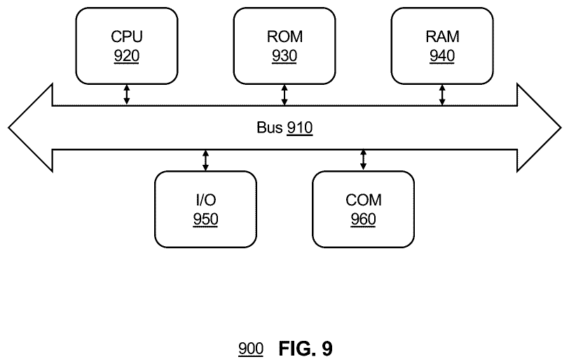

FIG. 9 depicts an example system that may execute techniques presented herein. FIG. 9 is a simplified functional block diagram of a computer that may be configured to execute techniques described herein, according to exemplary cases of the present disclosure. Specifically, the computer (or “platform” as it may not be a single physical computer infrastructure) may include a data communication interface 960 for packet data communication. The platform may also include a central processing unit (“CPU”) 920, in the form of one or more processors, for executing program instructions. The platform may include an internal communication bus 910, and the platform may also include a program storage and/or a data storage for various data files to be processed and/or communicated by the platform such as ROM 930 and RAM 940, although the system 900 may receive programming and data via network communications. The system 900 also may include input and output ports 950 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### 10. Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

### 11. Examples

Exemplary embodiments of the systems and methods disclosed herein are described in the numbered paragraphs below.

A1. A system comprising: at least one memory configured to store instructions; and at least one processor executing the instructions to perform operations, the operations comprising: processing a test instance through a machine learning model to obtain a set of inferences; detecting errors in the set of inferences and/or the machine learning model by evaluating model confidence, class confusability, consistency in predictions, and similarity to labeled examples; automatically correcting the errors in the set of inferences and/or updating the machine learning model using auxiliary models, rule-based approaches, and/or fine-tuning; determining post-hoc explanations for the errors using feature importance analysis, prototype-based explanations, and contrastive explanations; and outputting the post-hoc explanations to a user.

A2. The system of A1, wherein detecting the errors in the set of inferences and/or the machine learning model includes processing attributes of the set of inferences and/or the machine learning model through a meta-machine learning model to predict whether the test instance is an error case, wherein the meta-machine learning model is configured to combine error-indicating signals into a refined prediction.

A3. The system of A2, wherein detecting the errors includes evaluating the model confidence by assessing a probability associated with a prediction made by the machine learning model and identifying instances with low confidence as potential error cases.

A4. The system of A2, wherein detecting the errors includes analyzing the class confusability, wherein the system evaluates a margin between predicted class probabilities to determine a likelihood of the machine learning model confusing two or more classes.

A5. The system of A2, wherein detecting the errors includes measuring the consistency of the predictions of the machine learning model across similar or perturbed input instances, wherein variations in the predictions indicate potential errors.

A6. The system of A2, wherein detecting the errors includes comparing the test instance to the labeled examples from training data to identify potential inconsistencies or anomalies of the test instance, and the potential inconsistencies or anomalies are flagged as potential errors.

A7. The system of any of A1-A6, wherein automatically correcting the errors in the set of inferences includes correcting the errors in real-time using higher complexity auxiliary models and ensembles, wherein the auxiliary models and the ensembles are selected based on their ability to improve prediction accuracy in specific scenarios identified by the errors in the set of inferences and/or the machine learning model.

A8. The system of A7, wherein the auxiliary models and the ensembles are trained on different architectures or data subsets and aggregated to refine the predictions of the machine learning model, thereby enhancing an overall accuracy of the system.

A9. The system of A7, wherein automatically correcting the errors in the set of inferences includes applying rule-based approaches to correct the predictions of the machine learning model, wherein predefined logical constraints of the rule-based approaches are based on domain-specific knowledge and are applied to handle edge cases where a behavior of the machine learning model is known to falter.

A10. The system of A7, wherein automatically updating the machine learning model includes retraining the machine learning model on identified error cases using a fine-tuning process and/or a transfer learning process, wherein the fine-tuning process is configured to adjust parameters of the machine learning model on a subset of data that highlights weaknesses of the machine learning model, and the transfer learning process is configured to allow the system to adapt knowledge from pre-trained models to correct a behavior of the machine learning model.

A11. The system of any of A1-A10, wherein determining the post-hoc explanations includes applying the feature importance analysis, wherein the feature importance analysis is configured to identify influential features that contributed to an erroneous prediction of the machine learning model, thereby providing a ranked list of features based on impact of features of the ranked list of features.

A12. The system of A11, wherein the feature importance analysis is performed using methods selected from one or combinations of: permutation importance, SHAP values, and LIME, to thereby provide interpretable insights into a decision-making process of the machine learning model.

A13. The system of A11, wherein determining the post-hoc explanations includes identifying the prototype-based explanations, wherein the system is configured to find and compare the test instance with similar examples from training data, and provide insights into whether an error was due to a misinterpretation, of the machine learning model, of specific data patterns or an underrepresented class in the training data.

A14. The system of A11, wherein determining the post-hoc explanations includes generating the contrastive explanations, wherein the system is configured to compare a misclassified instance with correctly classified instances and identify specific features or characteristics that led to misclassification of the misclassified instance.

A15. The system of any of A1-A14, wherein the operations are applied to one or more domains selected from one or combinations of: classification, wherein the machine learning model assigns an input to one of several predefined categories; regression, wherein the machine learning model predicts a continuous value based on input data; object detection, wherein the machine learning model identifies and localizes objects within an image or video; object tracking, wherein the machine learning model follows an object across frames in a video sequence; and natural language processing, wherein the machine learning model performs tasks involving analysis and generation of human language.

A16. The system of any of A1-A15, wherein the system is configured for error detection, correction, and explainability in unlabeled deployment data, wherein the system is configured to operate without reliance on labeled ground truth during deployment, and is further configured to detect errors based on model uncertainty, class confusability, and other attributes, and correct the errors using auxiliary models, rule-based approaches, and updating the machine learning model in real-time or batch processing to adapt to new environments or data distributions.

A17. The system of any of A1-A16, wherein the operations further include a feedback loop, wherein the errors are used to continually improve error detection, wherein the system is configured to incorporate newly detected errors into a training process to enhance future error detection accuracy.

A18. The system of any of A1-A17, wherein detecting the errors and correcting the errors, as deployed in an error detection and correction framework, are integrated into a cloud-based machine learning platform, allowing for scalable deployment and continuous updates, ensuring that the system remains up-to-date with latest data and model improvements.

A19. The system of any of A1-A18, wherein the machine learning model automatically selects auxiliary models based on a specific type of error detected, optimizing a correction process by leveraging the auxiliary models to address the specific type of error detected, and the auxiliary models are selected based on a selection criteria that indicates selection based on improvement of the machine learning model.

A20. A computer-implemented method comprising: processing a test instance through a machine learning model to obtain a set of inferences; detecting errors in the set of inferences and/or the machine learning model by evaluating model confidence, class confusability, consistency in predictions, and similarity to labeled examples; automatically correcting the errors in the set of inferences and/or updating the machine learning model using auxiliary models, rule-based approaches, and/or fine-tuning; determining post-hoc explanations for the errors using feature importance analysis, prototype-based explanations, and contrastive explanations; and outputting the post-hoc explanations to a user.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system comprising:
at least one memory configured to store instructions; and
at least one processor executing the instructions to perform operations, the operations comprising:
processing a test instance through a machine learning model to obtain a set of inferences;
detecting errors in the set of inferences and/or the machine learning model by evaluating model confidence, class confusability, consistency in predictions, and similarity to labeled examples;
automatically correcting the errors in the set of inferences and/or updating the machine learning model using auxiliary models, rule-based approaches, and/or fine-tuning;
determining post-hoc explanations for the errors using feature importance analysis, prototype-based explanations, and contrastive explanations; and
outputting the post-hoc explanations to a user.

2. The system of claim 1, wherein detecting the errors in the set of inferences and/or the machine learning model includes processing attributes of the set of inferences and/or the machine learning model through a meta-machine learning model to predict whether the test instance is an error case, wherein the meta-machine learning model is configured to combine error-indicating signals into a refined prediction.

3. The system of claim 2, wherein detecting the errors includes evaluating the model confidence by assessing a probability associated with a prediction made by the machine learning model and identifying instances with low confidence as potential error cases.

4. The system of claim 2, wherein detecting the errors includes analyzing the class confusability, wherein the system evaluates a margin between predicted class probabilities to determine a likelihood of the machine learning model confusing two or more classes.

5. The system of claim 2, wherein detecting the errors includes measuring the consistency of the predictions of the machine learning model across similar or perturbed input instances, wherein variations in the predictions indicate potential errors.

6. The system of claim 2, wherein detecting the errors includes comparing the test instance to the labeled examples from training data to identify potential inconsistencies or anomalies of the test instance, and the potential inconsistencies or anomalies are flagged as potential errors.

7. The system of claim 1, wherein automatically correcting the errors in the set of inferences includes correcting the errors in real-time using higher complexity auxiliary models and ensembles, wherein the auxiliary models and the ensembles are selected based on their ability to improve prediction accuracy in specific scenarios identified by the errors in the set of inferences and/or the machine learning model.

8. The system of claim 7, wherein the auxiliary models and the ensembles are trained on different architectures or data subsets and aggregated to refine the predictions of the machine learning model, thereby enhancing an overall accuracy of the system.

9. The system of claim 7, wherein automatically correcting the errors in the set of inferences includes applying rule-based approaches to correct the predictions of the machine learning model, wherein predefined logical constraints of the rule-based approaches are based on domain-specific knowledge and are applied to handle edge cases where a behavior of the machine learning model is known to falter.

10. The system of claim 7, wherein automatically updating the machine learning model includes retraining the machine learning model on identified error cases using a fine-tuning process and/or a transfer learning process, wherein the fine-tuning process is configured to adjust parameters of the machine learning model on a subset of data that highlights weaknesses of the machine learning model. and the transfer learning process is configured to allow the system to adapt knowledge from pre-trained models to correct a behavior of the machine learning model.

11. The system of claim 1, wherein determining the post-hoc explanations includes applying the feature importance analysis, wherein the feature importance analysis is configured to identify influential features that contributed to an erroneous prediction of the machine learning model, thereby providing a ranked list of features based on impact of features of the ranked list of features.

12. The system of claim 11, wherein the feature importance analysis is performed using methods selected from one or combinations of: permutation importance, SHAP values, and LIME, to thereby provide interpretable insights into a decision-making process of the machine learning model.

13. The system of claim 11, wherein determining the post-hoc explanations includes identifying the prototype-based explanations, wherein the system is configured to find and compare the test instance with similar examples from training data, and provide insights into whether an error was due to a misinterpretation, of the machine learning model, of specific data patterns or an underrepresented class in the training data.

14. The system of claim 11, wherein determining the post-hoc explanations includes generating the contrastive explanations, wherein the system is configured to compare a misclassified instance with correctly classified instances and identify specific features or characteristics that led to misclassification of the misclassified instance.

15. The system of claim 1, wherein the operations are applied to one or more domains selected from one or combinations of: classification, wherein the machine learning model assigns an input to one of several predefined categories; regression, wherein the machine learning model predicts a continuous value based on input data; object detection, wherein the machine learning model identifies and localizes objects within an image or video; object tracking, wherein the machine learning model follows an object across frames in a video sequence; and natural language processing, wherein the machine learning model performs tasks involving analysis and generation of human language.

16. The system of claim 1, wherein the system is configured for error detection, correction, and explainability in unlabeled deployment data, wherein the system is configured to operate without reliance on labeled ground truth during deployment, and is further configured to detect errors based on model uncertainty, class confusability, and other attributes, and correct the errors using auxiliary models, rule-based approaches, and updating the machine learning model in real-time or batch processing to adapt to new environments or data distributions.

17. The system of claim 1, wherein the operations further include a feedback loop, wherein the errors are used to continually improve error detection, wherein the system is configured to incorporate newly detected errors into a training process to enhance future error detection accuracy.

18. The system of claim 1, wherein detecting the errors and correcting the errors, as deployed in an error detection and correction framework, are integrated into a cloud-based machine learning platform, allowing for scalable deployment and continuous updates, ensuring that the system remains up-to-date with latest data and model improvements.

19. The system of claim 1, wherein the machine learning model automatically selects auxiliary models based on a specific type of error detected, optimizing a correction process by leveraging the auxiliary models to address the specific type of error detected, and the auxiliary models are selected based on a selection criteria that indicates selection based on improvement of the machine learning model.

20. A computer-implemented method comprising:
processing a test instance through a machine learning model to obtain a set of inferences;
detecting errors in the set of inferences and/or the machine learning model by evaluating model confidence, class confusability, consistency in predictions, and similarity to labeled examples;
automatically correcting the errors in the set of inferences and/or updating the machine learning model using auxiliary models, rule-based approaches, and/or fine-tuning;
determining post-hoc explanations for the errors using feature importance analysis, prototype-based explanations, and contrastive explanations; and
outputting the post-hoc explanations to a user.
